(19) United States
(12) Patent Application Publication
(10) Pub. No.: US 2022/0253750 A1
(43) Pub. Date: Aug. 11, 2022

(54) COMPUTER-READABLE RECORDING MEDIUM STORING MODEL GENERATION PROGRAM, METHOD OF GENERATING MODEL, AND MODEL GENERATION APPARATUS

(71) Applicant: FUJITSU LIMITED, Kawasaki-shi (JP)

(72) Inventor: Yoshinobu Iimura, Kawasaki (JP)

(73) Assignee: FUJITSU LIMITED, Kawasaki-shi (JP)

(21) Appl. No.: 17/523,595

(22) Filed: Nov. 10, 2021

(30) Foreign Application Priority Data
Feb. 8, 2021 (JP) 2021-018049

(51) Int. Cl. G06N 20/20; G06N 7/00; G05B 13/02

(52) U.S. Cl. CPC G06N 20/20; G06N 7/005; G05B 13/024; G05B 13/026; G05B 13/0265

(57) ABSTRACT

A non-transitory computer-readable recording medium stores a model generation program for causing a computer to execute a process including: obtaining a plurality of pieces of data; inputting the plurality of pieces of data to a first model and obtaining a plurality of prediction results; determining importance of each of the plurality of pieces of data based on the plurality of prediction results; and generating a second model based on the determined importance and the plurality of pieces of data.

### CROSS-REFERENCE TO RELATED APPLICATION

This application is based upon and claims the benefit of priority of the prior Japanese Patent Application No. 2021-18049, filed on Feb. 8, 2021, the entire contents of which are incorporated herein by reference.

### FIELD

The embodiment discussed herein is related to a computer-readable recording medium storing a model generation program, a method of generating a model, and a model generation apparatus.

### BACKGROUND

For example, in control of an automobile engine, control parameters of an electronic control unit (ECU) for engine control are optimized so as to optimize evaluation indices such as fuel efficiency and NOx.

Japanese Laid-open Patent Publication Nos. 2012-13637 and 2007-40929 are disclosed as related art.

### SUMMARY

According to an aspect of the embodiments, a non-transitory computer-readable recording medium stores a model generation program for causing a computer to execute a process including: obtaining a plurality of pieces of data; inputting the plurality of pieces of data to a first model and obtaining a plurality of prediction results; determining importance of each of the plurality of pieces of data based on the plurality of prediction results; and generating a second model based on the determined importance and the plurality of pieces of data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional configuration of an information processing apparatus as an example of the embodiment;

FIG. 2 explains input data in the information processing apparatus as the example of the embodiment;

FIG. 3 explains the input data in the information processing apparatus as the example of the embodiment;

FIG. 4 is a flowchart that explains a control parameter setting process in the information processing apparatus as the example of the embodiment;

FIG. 5 is a diagram in which an optimum parameter of a statistical model according to the related-art technique and an optimum parameter of a true engine model are compared with each other;

FIG. 6 illustrates an example in which a control parameter setting function of the information processing apparatus as the example of the embodiment is applied to a steady-state torque maximization problem; and

FIG. 7 illustrates an example of a hardware configuration of the information processing apparatus as the example of the embodiment.

### DESCRIPTION OF EMBODIMENTS

Examples of the control parameters include, for example, a fuel injection amount, the start of injection (SOI), a fuel pressure, an exhaust gas recirculation (EGR) rate, a variable geometry turbo (VGT) rate, an engine rotation law, and so forth.

However, such control of the automobile engine is becoming complex and advancing, and the number of control parameters in the ECU for engine control is increasing. Thus, manual adjustment of the control parameters is difficult.

Accordingly, in recent years, an experimental design method has been used to obtain data, statistical modeling has been performed based on the obtained data, and optimum control parameters have been set based on the behavior of the created statistical model.

However, in the related-art technique in which data obtaining in accordance with such an experimental design method is used, when a statistical model is created with the obtained data, accuracy may be degraded around true optimum values of the control parameters, and the control parameters are not necessarily appropriately set.

In one aspect, an object of the present disclosure is to generate a model with high accuracy in a specific region.

An embodiment of a model generation program, a method of generating a model, and a model generation apparatus will be described below with reference to the drawings. However, the following embodiment is merely an example and does not intend to exclude application of various modification examples or techniques that are not explicitly described in the embodiment. For example, the present embodiment may be modified in a various manner and carried out without departing from the spirit of the embodiment. Each drawing does not indicate that only components illustrated in the drawing are provided.

The drawings indicate that other functions and the like may be included.

(A) Configuration

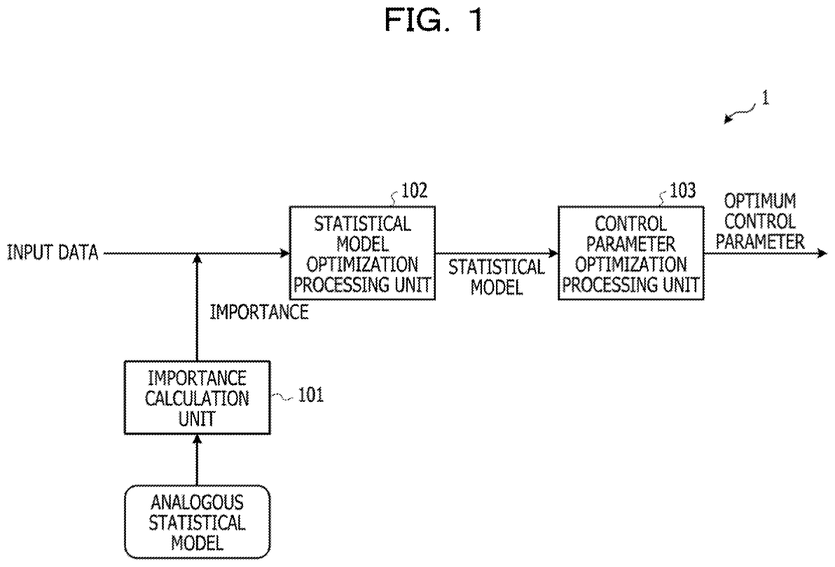

FIG. 1 illustrates an example of a functional configuration of an information processing apparatus 1 as an example of the embodiment.

The information processing apparatus 1 realizes, for example, a control parameter setting function for setting control parameters of an engine of an automobile or a motorcycle.

In the following example, regarding exhaust gas regulations, a combination of values of the start of injection (SOI) and nitrogen oxide (NOx) with which particulate matter (PM) is minimized is determined as a control parameter.

As illustrated in FIG. 1, the information processing apparatus 1 includes the functions as an importance calculation unit 101, a statistical model optimization processing unit 102, and a control parameter optimization processing unit 103.

For example, data obtained in accordance with a plan set by an experimental design is input to the information processing apparatus 1. Hereinafter, data input to the information processing apparatus 1 may be referred to as input data.

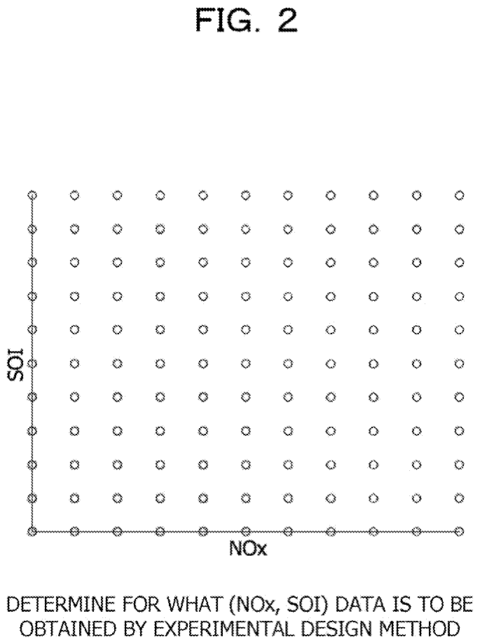

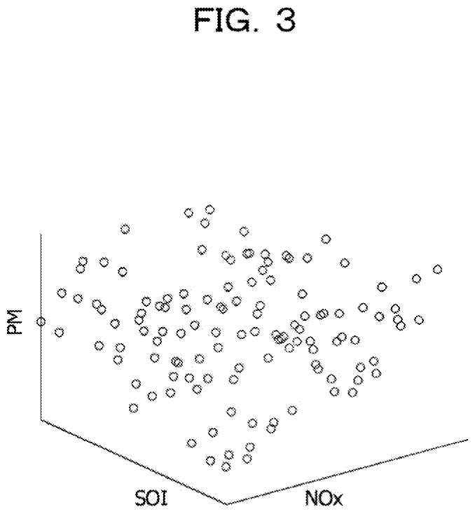

FIGS. 2 and 3 explain the input data in the information processing apparatus 1 as the example of the embodiment.

FIG. 2 illustrates examples of combinations of NOx and the SOI for which data obtaining is determined by the experimental design. In FIG. 2, blank circles indicate data to be obtained. FIG. 3 illustrates an example of the PM measured for the combinations of NOx and the SOI exemplified in FIG. 2. In FIG. 3, blank circles indicate obtained (measured) data.

For the information processing apparatus 1, the combinations of NOx, the SOI, and the PM obtained as described above are used as the input data. The input data is used to train a statistical model (machine learning model). The input data may be referred to as training data.

The importance calculation unit 101 quantitatively obtains the importance of each piece of data by calculating the importance of a predicted value (model predicted value) of a known engine statistical model for the purpose of control parameter optimization (for example, exhaust gas regulation).

For example, a statistical model is expressed by the following expression (1).

y=f(x;θ) (1)

In expression (1), y is a variable (for example, fuel efficiency or NOx) desired to be optimized, x is a design variable (for example, a fuel injection amount, the SOI, a fuel pressure, an exhaust gas recirculation (EGR) rate, a variable geometry turbo (VGT) rate, or an engine rotation law), and θ is a model parameter.

The statistical model represented by expression (1) described above corresponds to a statistical model before retraining performed by the statistical model optimization processing unit 102, which will be described later, by using the input data. For example, the statistical model represented by expression (1) is an analogous model (first model) analogous to a statistical model (second model) generated by the statistical model optimization processing unit 102. The analogous model is a trained (having undergone machine learning) statistical model (machine learning model). The analogous model may be referred to as an analogous statistical model.

The importance calculation unit 101 inputs a plurality of pieces of the input data to the analogous statistical model to obtain a plurality of prediction results for the pieces of the input data. The importance calculation unit 101 determines the importance (weight, sensitivity) of each of the plurality of pieces of the input data based on the plurality of prediction results.

For example, the importance calculation unit 101 calculates an importance wi for each piece of the input data based on expression (2) described below.

$${{w}_{i} = \frac{\partial f ( x ; θ )}{\partial θ} \frac{- \frac{\partial }{\partial θ} log f ( {x}_{i} ; θ )}{\{ \sum \frac{{\partial }^{2}}{\partial {θ}^{2}} log f ( {x}_{i} ; θ ) \}} \vert}_{x = {x}_{i}} \qquad ( 2 )$$

In expression (2), i represents an index of the input data.

The importance wi represents a slope (of prediction) of a statistical model (analogous statistical model) related to a purpose of the simultaneous optimization (for example, an item desired to be optimized such as fuel efficiency). The importance wi becomes large around (data of) the true optimum value and becomes small in the other portions.

The importance wi corresponds to the reciprocal of the slope of the approximate curve of the analogous statistical model. This slope may be referred to as sensitivity.

The statistical model optimization processing unit 102 generates an optimized statistical model (second model) by using the importance calculated by the importance calculation unit 101.

The statistical model optimization processing unit 102 solves an optimization problem represented by expression (4) under a constraint condition represented by expression (3) described below to obtain a design variable x with which y is minimized and set an optimized statistical model. For example, the statistical model optimization processing unit 102 generates the optimized statistical model by retraining the statistical model by using the input data. Thus, the information processing apparatus 1 functions as a model generation apparatus.

$$\begin{matrix}sub . to {θ}^{*} = {argmax}_{θ} {\sum }_{i = 1}^{T} {w}_{i} log f * ( {y}_{i} \vert {x}_{i} ; θ ) & ( 3 ) \\ {min}_{x} y = f ( x ; {θ}^{*} ) & ( 4 )\end{matrix}$$

In expressions (3) and (4), θ* represents the optimized model parameter (optimization model parameter).

As described above, the importance wi becomes large at the data around the true optimum value (extremum) and becomes small in the other portions. Thus, in the optimized statistical model set by the statistical model optimization processing unit 102, fitting for increasing the importance wi around the optimum value is performed. This may improve prediction accuracy around the optimum value. When statistically represented, for example, the Kullback-Leibler divergence around the optimum value is particularly decreased in the optimized statistical model.

As described above, the statistical model optimization processing unit 102 generates a statistical model in which the model parameters are optimized by using the importance wi as a weight.

The control parameter optimization processing unit 103 estimates the control parameters (for example, the fuel injection amount, the SOI, the fuel pressure, the EGR rate, the VGT rate, and the engine rotation law) by using the statistical model set by the statistical model optimization processing unit 102.

The estimation of the control parameters by using the statistical model is known, and the detailed description thereof is omitted.

The control parameter optimization processing unit 103 estimates the control parameters by using the statistical model in which the model parameter is optimized, thereby the optimized control parameters (optimum control parameters) are output.

(B) Operation

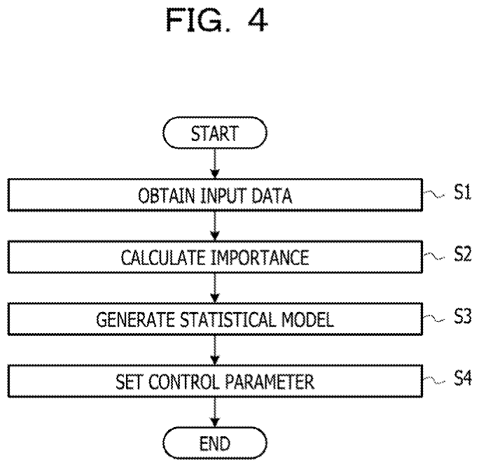

A control parameter setting process in the information processing apparatus 1 as the example of the embodiment configured as described above is described in accordance with a flowchart (steps S1 to S4) illustrated in FIG. 4.

In step S1, the importance calculation unit 101 obtains the plurality of pieces of the input data.

In step S2, the importance calculation unit 101 calculates the importance wi for each piece of the input data based on expression (2) described above.

In step S3, the statistical model optimization processing unit 102 solves the optimization problem represented by expression (4) under the constraint condition represented by expression (3) described above to obtain the design variable x with which y is minimized and set the optimized statistical model.

In step S4, the control parameter optimization processing unit 103 estimates the control parameter by using the statistical model set by the statistical model optimization processing unit 102 and ends processing.

(C) Effects

As described above, with the information processing apparatus 1 as the example of the embodiment, the importance calculation unit 101 calculates the importance wi for each piece of the input data, and the statistical model optimization processing unit 102 generates the optimized statistical model by using the importance calculated by the importance calculation unit 101.

The statistical model optimization processing unit 102 generates the optimized statistical model by using the calculated importance as the weight.

The importance wi becomes large at the data around the true optimum value (extremum) and becomes small in the other portions. Thus, in the statistical model set by the statistical model optimization processing unit 102, fitting for increasing the importance wi around the optimum value is performed. This may improve the prediction accuracy around the optimum value.

A statistical model with high accuracy around the optimum value of the control parameter may be obtained, and a model with high accuracy in a specific region may be generated.

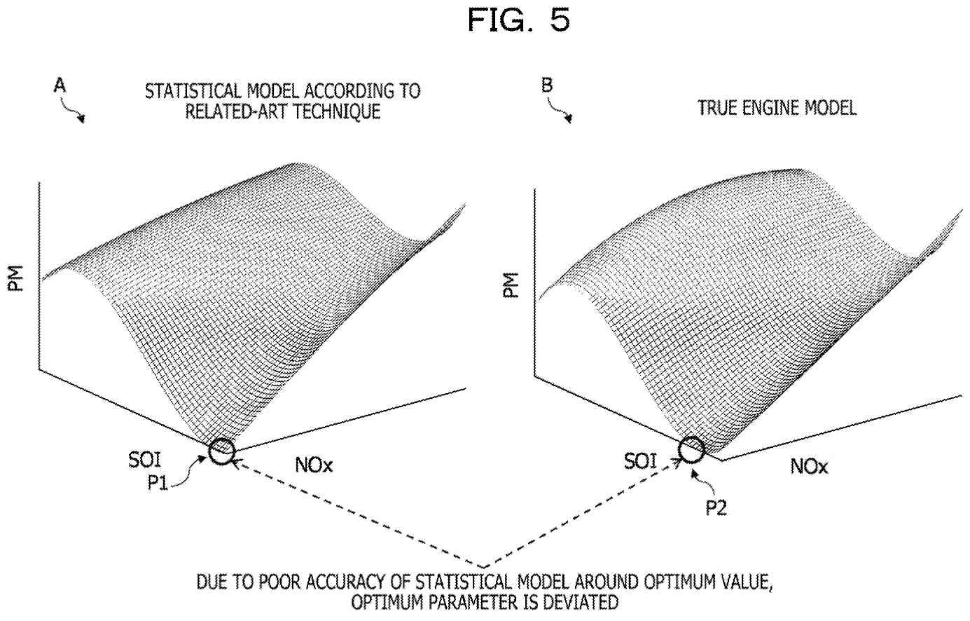

FIG. 5 is a diagram in which the optimum parameter of the statistical model according to the related-art technique and the optimum parameter of the true engine model are compared with each other.

In FIG. 5, a reference sign A denotes the statistical model according to the related-art technique, and a reference sign B denotes the true engine model. In each of these models, the PM is represented in combination with the SOI and NOx.

A control parameter (optimum parameter) with which the value of the PM is minimized in the statistical model according to the related-art technique is denoted by a reference sign P1, and a control parameter (optimum parameter) with which the value of the PM is minimized in the true engine model is denoted by a reference sign P2.

Since the accuracy of the statistical model according to the related-art technique is poor around the optimum value, the optimum parameter obtained by the related-art technique (see the reference sign P1) deviates from the optimum parameter of the true engine model (see the reference sign P2) as represented by these reference signs P1 and P2.

The amount of data able to be obtained by measurement is limited, and when the accuracy of the statistical model created according to the related-art technique by using the obtained data is insufficient around the true optimum value of the control parameter, the control parameter is not necessarily appropriately set.

In contrast, in the information processing apparatus 1, the importance of each piece of the data is quantitatively obtained by calculating the sensitivity of a predicted value of a past analogous engine statistical model for the purpose of control parameter optimization (for example, exhaust gas regulation), and the prediction accuracy around the optimum value may be improved by using this importance as the weight.

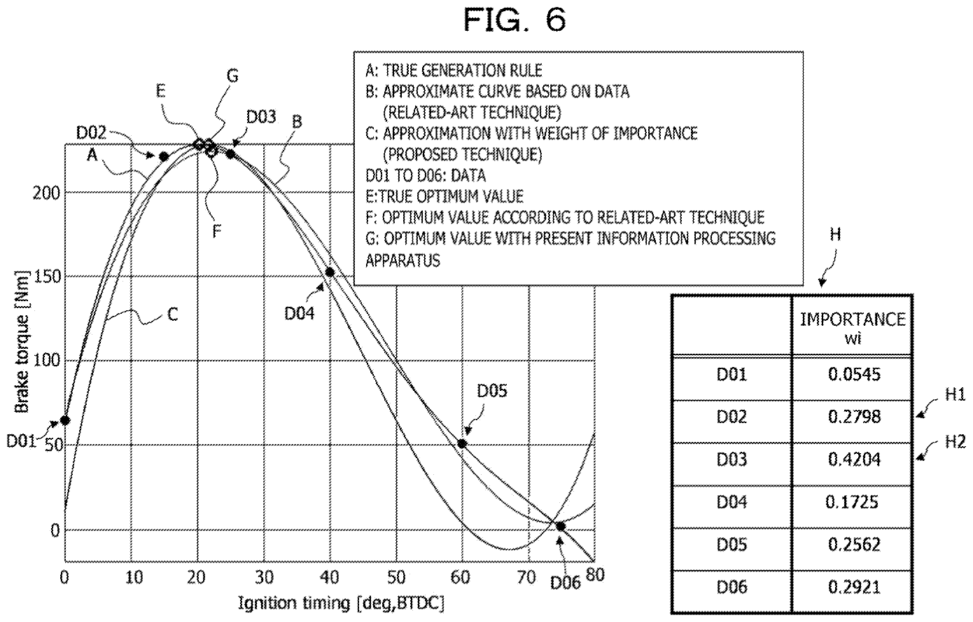

FIG. 6 illustrates an example in which the control parameter setting function of the information processing apparatus 1 as the example of the embodiment is applied to a steady-state torque maximization problem.

FIG. 6 illustrates the relationship between ignition timing and break torque. For example, a true generation rule (see a reference sign A), an approximate curve based on the data by using a related-art technique for the true generation rule (see a reference sign B), and an approximate curve based on the statistical model optimized by the present information processing apparatus 1 (see a reference sign C) are illustrated.

Also in FIG. 6, a reference sign H denotes examples of the importance calculated by the importance calculation unit 101 for individual pieces of data D01 to D06 on the curve representing the true generation rule (see the reference sign A). The value of the importance increases (refer to reference signs H1 and H2) around the true optimum value (refer to a reference sign E) in the true generation rule (refer to the reference sign A).

Also in FIG. 6, the true optimum value in the true generation rule (see the reference sign A) is denoted by the reference sign E. The true optimum value corresponds to an extremum (local maximum value) in the true generation rule. In FIG. 6, the true optimum value (reference sign E) is the true maximum torque (228.3319 Nm).

An optimum value in the approximate curve based on the data by using the related-art technique (see the reference sign B) is denoted by reference sign F. In FIG. 6, the maximum torque with the related-art technique is 227.3814 Nm.

The optimum value in the approximate curve based on the statistical model optimized by the present information processing apparatus 1 (see the reference sign C) is denoted by a reference sign G. The maximum torque with the present information processing apparatus 1 is 227.7925 Nm.

As described above, the optimum value with the present information processing apparatus 1 (the maximum torque 227.7925 Nm: see the reference sign G) is closer to the true optimum value (the maximum torque 228.3319 Nm: see the reference sign E) than the optimum value with the related-art technique (the maximum torque 227.3814 Nm: see the reference sign F), and it may be understood that the optimum value with the information processing apparatus 1 is highly accurate.

(D) Others

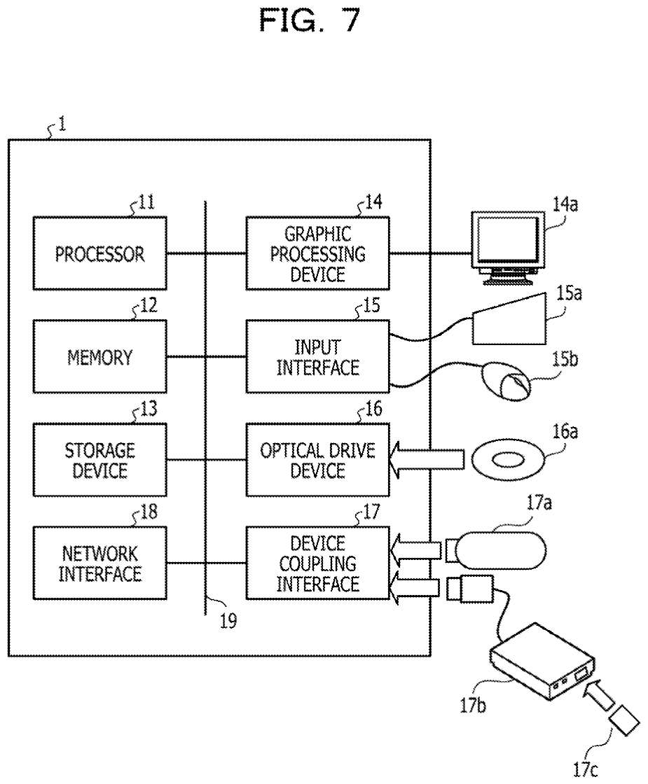

FIG. 7 illustrates an example of a hardware configuration of the information processing apparatus 1 as the example of the embodiment.

The information processing apparatus 1 is a computer that includes, for example, a processor 11, a memory 12, a storage device 13, a graphic processing device 14, an input interface 15, an optical drive device 16, a device coupling interface 17, and a network interface 18 as components. These components 11 to 18 are configured so as to be mutually communicable via a bus 19.

The processor (control unit) 11 controls the entire information processing apparatus 1. The processor 11 may be a multiprocessor. For example, the processor 11 may be any one of a central processing unit (CPU), a microprocessor unit (MPU), a digital signal processor (DSP), an application-specific integrated circuit (ASIC), a programmable logic device (PLD), and a field-programmable gate array (FPGA). The processor 11 may be a combination of two or more types of elements of the CPU, the MPU, the DSP, the ASIC, the PLD, and the FPGA.

The processor 11 executes a control program (model generation program: not illustrated) for the information processing apparatus 1, thereby realizing the functions as the importance calculation unit 101, the statistical model optimization processing unit 102, and the control parameter optimization processing unit 103 illustrated in FIG. 1.

The information processing apparatus 1 executes, for example, programs (the model generation program and the OS program) recorded in a computer-readable non-transitory recording medium, thereby realizing the functions as the importance calculation unit 101, the statistical model optimization processing unit 102, and the control parameter optimization processing unit 103.

The information processing apparatus 1 may executes a program (experimental design program) recorded in a computer-readable non-transitory recording medium, thereby realizing an input data obtaining plan based on the experimental design and generating input data.

Programs in which content of processing to be executed by the information processing apparatus 1 is described may be recorded in various recording media. For example, the programs to be executed by the information processing apparatus 1 may be stored in the storage device 13. The processor 11 loads at least a subset of the programs in the storage device 13 into the memory 12 and executes the loaded program or programs.

The programs to be executed by the information processing apparatus 1 (processor 11) may be recorded in a non-transitory portable recording medium such as an optical disc 16a, a memory device 17a, and a memory card 17c. For example, the programs stored in the portable recording media become executable after being installed in the storage device 13 by control from the processor 11. The processor 11 may read the programs directly from the portable recording media and execute the programs.

The memory 12 is a storage memory including a read-only memory (ROM) and a random-access memory (RAM). The RAM of the memory 12 is used as a main storage device of the information processing apparatus 1. The programs to be executed by the processor 11 are at least partially stored in the RAM temporarily. In the memory 12, various types of data desired for the processing by the processor 11 are stored.

The storage device 13 is a storage device such as a hard disk drive (HDD), a solid-state drive (SSD), or a storage class memory (SCM) and stores various types of data. The storage device 13 is used as an auxiliary storage device of the information processing apparatus 1.

The OS program, the control program, and the various types of data are stored in the storage device 13. The control program includes the model generation program.

As the auxiliary storage device, a semiconductor storage device such as an SCM or a flash memory may be used. A plurality of storage devices 13 may be used to configure redundant arrays of inexpensive disks (RAID).

The storage device 13 may store, for example, the input data, the importance generated by the importance calculation unit 101, information indicating the statistical model and the optimization model parameter generated by the statistical model optimization processing unit 102, and the optimum control parameters generated by the control parameter optimization processing unit 103.

A monitor 14a is coupled to the graphic processing device 14. The graphic processing device 14 displays an image on a screen of the monitor 14a in accordance with an instruction from the processor 11. Examples of the monitor 14a include a display device with a cathode ray tube (CRT), a liquid crystal display device, and the like.

A keyboard 15a and a mouse 15b are coupled to the input interface 15. The input interface 15 transmits signals transmitted from the keyboard 15a and the mouse 15b to the processor 11. The mouse 15b is an example of a pointing device, and a different pointing device may be used. Examples of the different pointing device include a touch panel, a tablet, a touch pad, a track ball, and the like.

The optical drive device 16 reads data recorded in the optical disc 16a by using laser light or the like. The optical disc 16a is a portable non-transitory recording medium in which data is recorded so that the data is readable using light reflection. Examples of the optical disc 16a include a Digital Versatile Disc (DVD), a DVD-RAM, a compact disc read-only memory (CD-ROM), a CD-recordable (R)/CD-rewritable (RW), and the like.

The device coupling interface 17 is a communication interface for coupling peripheral devices to the information processing apparatus 1. For example, the memory device 17a or a memory reader-writer 17b may be coupled to the device coupling interface 17. The memory device 17a is a non-transitory recording medium such as a Universal Serial Bus (USB) memory which has the function of communication with the device coupling interface 17. The memory reader-writer 17b writes data to the memory card 17c or reads data from the memory card 17c. The memory card 17c is a card-type non-transitory recording medium.

The network interface 18 is coupled to a network. The network interface 18 transmits and receives data via the network. Other information processing apparatuses, communication devices, or the like may be coupled to the network. The network interface 18 may be coupled to another information processing apparatus that generates input data or a storage system that stores the generated input data.

The disclosed technique is not limited to the embodiment described above and may be carried out with various modifications without departing from the gist of the present embodiment. The configurations and the processes of the present embodiment may be selected as desired or may be combined as appropriate.

For example, in the above-described embodiment, the example in which the control parameter setting function of the information processing apparatus 1 is applied to the setting of the control parameters of the engine is described. However, this is not limiting. For example, the present disclosure may be applied to setting of control parameters of a variety of other control systems and may be appropriately changed and carried out.

The above-described disclosure enables a person skilled in the art to carry out and manufacture the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a model generation program for causing a computer to execute a process, the process comprising:
obtaining a plurality of pieces of data;
inputting the plurality of pieces of data to a first model and obtaining a plurality of prediction results;
determining importance of each of the plurality of pieces of data based on the plurality of prediction results; and
generating a second model based on the determined importance and the plurality of pieces of data.

2. The computer-readable recording medium according to claim 1, wherein
the importance is calculated based on a slope related to data in the first model.

3. The computer-readable recording medium according to claim 1, wherein
a model parameter of the second model is calculated by using the importance as a weight of a maximum likelihood estimation expression.

4. A method of generating a model comprising:
obtaining, by a computer, a plurality of pieces of data;
inputting the plurality of pieces of data to a first model and obtaining a plurality of prediction results;
determining importance of each of the plurality of pieces of data based on the plurality of prediction results; and
generating a second model based on the determined importance and the plurality of pieces of data.

5. The method according to claim 4, wherein
the importance is calculated based on a slope related to data in the first model.

6. The method according to claim 4 wherein
a model parameter of the second model is calculated by using the importance as a weight of a maximum likelihood estimation expression.

7. An information processing apparatus comprising:
a memory; and
a processor coupled to the memory and configured to:
obtain a plurality of pieces of data;
input the plurality of pieces of data to a first model and obtaining a plurality of prediction results;
determine importance of each of the plurality of pieces of data based on the plurality of prediction results; and
generate a second model based on the determined importance and the plurality of pieces of data.

8. The information processing apparatus according to claim 7, wherein
the importance is calculated based on a slope related to data in the first model.

9. The information processing apparatus according to claim 7 wherein
a model parameter of the second model is calculated by using the importance as a weight of a maximum likelihood estimation expression.
